(19) United States
(12) Patent Application Publication
(10) Pub. No.: US 2026/0055832 A1
(43) Pub. Date: Feb. 26, 2026

(54) O-RING SEALING USING TRIANGULAR GLAND GEOMETRY

(71) Applicant: Parker-Hannifin Corporation, Cleveland, OH (US)

(72) Inventors: John P. Blomberg, New Ulm, MN (US); Cole J. Bohnert, Eagle Lake, MN (US)

(73) Assignee: Parker-Hannifin Corporation, Cleveland, OH (US)

(21) Appl. No.: 19/104,299

(22) PCT Filed: Aug. 23, 2023
(86) PCT No.: PCT/US2023/072689

§ 371 Date: Feb. 17, 2025

Related U.S. Application Data
(60) Provisional application No. 63/376,132, filed on Sep. 19, 2022.

(51) Int. Cl. F16L 19/065; F16J 15/02; F16L 19/07

(52) U.S. Cl. CPC F16L 19/065; F16J 15/022; F16L 19/07

(57) ABSTRACT

A fluid system includes a fluid manifold, a rear end cap fixed to the fluid manifold and having an internal first cone-shaped recess, and a fluid tube having an end positioned in the fluid manifold and that extends from the fluid manifold through the rear end cap. The fluid system further includes a sealing insert that extends around a portion of the fluid tube, the sealing insert having a first end positioned in the fluid manifold and a second end positioned in the rear end cap. The second end has a second coned-shaped recess that is positioned as an opposing cone-shaped recess relative to the first coned-shaped recess. The opposing first and second cone-shaped recesses form a triangular sealing groove in which a long side or hypotenuse of the triangular sealing groove is an outer surface of the fluid tube, and a sealing element is positioned crushed within the triangular sealing groove.

### FIELD OF INVENTION

The present application relates generally to sealing configurations that employ triangular O-ring sealing glands, commonly referred to as crush sealing glands, as may be used for example in sealing coolant system components in motor applications.

### BACKGROUND OF THE INVENTION

A static axial seal can be implemented using an O-ring sealing element that is squeezed on both the top and bottom of the O-ring's cross section. When used as a face seal involving either internal or external pressure, the O-ring typically is seated against the low-pressure side of a groove in which the O-ring is situated. In a particular type of static seal implementation commonly referred to as a “crush” seal configuration, the O-ring is completely confined and pressure-deformed (crushed) within a triangular sealing groove or gland. An example of a common application for a crush seal configuration is for sealing the components of a coolant system for a motor.

FIG. 1 is a drawing depicting a conventional crush seal configuration. An exemplary fluid system 10 includes a fluid manifold 12 that is a source of fluid to be sourced through a fluid tube 14. A portion of the fluid tube 14 thus extends into the manifold 12 to receive fluid from the manifold. A rear end cap 16 is situated facing against the manifold 12 and around a portion of the fluid tube 14 that extends from the manifold 12. To prevent fluid leakage, therefore, three component interfaces must be sealed including the fluid manifold/rear end cap interface 18, the fluid manifold/fluid tube interface 20, and the fluid tube/rear end cap interface 22. To provide such a three-interface sealing, an O-ring 24 is positioned with a triangular sealing groove or gland 26, also referred to as a crush sealing gland because the O-ring is deformed or crushed within the triangular groove. The three sides of the triangular groove 26 correspond respectively to surfaces of the fluid manifold 12, fluid tube 14, and rear end cap 16. In an example application, the fluid may be a coolant fluid that is delivered via the fluid tube 14 for cooling a motor, although comparable principles may apply to any comparable fluid system.

In conventional configurations, as seen in FIG. 1, for simplicity of manufacturing the hypotenuse of the triangular sealing groove 26 typically is the surface of the fluid manifold 12. As shown in the close-up portion of FIG. 1, the triangular sealing groove typically is shaped as an isosceles right triangle. With such triangular seal configuration of an isosceles right triangle, the O-Ring has three main loads that are applied at the three sides of the triangular sealing groove. The three main loads are characterized by the following features: (1) the vector sum of Loads 1, 2, and 3=0; (2) Load 1 is approximately equal to Load 2; and (3) due to the configuration as an isosceles right triangle, Load 3 is approximately equivalent to square-root-two (or approximately 1.414) times either Load 1 or Load 2. Accordingly, the higher of the loads is applied at Load 3, and this results in a higher pressure and larger contact area being applied at Load 3. This higher pressure and wider sealing contact area generally provides enhanced sealing at the hypotenuse side of the triangular sealing groove 26 as compared to the leg sides of the triangular sealing groove 26. As referenced above, conventional sealing configurations have oriented the hypotenuse of the triangular sealing groove typically as the surface of the fluid manifold.

A problem associated with O-ring seals is that O-ring seals require a relatively good surface finish of the sealed components to seal properly. For the rear end cap and fluid manifold components, providing an effective surface finish is not problematic as such components can be machined to have the requisite surface finish. The surface finish of the fluid tube, however, can be more problematic. In many applications, the fluid tube is formed from copper tubing or similar material. Copper tubing (or similar) typically has a good surface finish when the tubing arrives at the manufacturer of the overall fluid system, but during manufacturing processes of the fluid system, including incorporation of the fluid tube with the fluid manifold and rear end cap, the fluid tube surface finish can be damaged. Often, such manufacturing damage of the fluid tube surface finish renders the surface finish substantially deficient relative to the recommended surface finish for proper O-ring sealing. Accordingly, because of surface finish damage the highest propensity for leakage tends to be at the component interfaces including the surface of the fluid tube, and yet in conventional configurations as described above, the strongest sealing load is at the manifold surface that constitutes the hypotenuse of the conventional triangular groove.

Attempts have been made to remedy sealing deficiencies caused by damage to the surface finish of the fluid tube during manufacturing of the fluid system. Some attempts have involved restoring the surface finish of the fluid tube to be requisite for proper O-ring sealing. For example, one method is to sand or abrade the surface of the tubing, which can restore the surface finish but otherwise may introduce particulates internally into the tubing and adds to labor costs. The inside of the tubing must remain clean from non-copper constituents, and non-copper particles from the abrasive process could be detrimental to the coolant system. Another method is to apply an RTV (room-temperature-vulcanizing) substance to the surface of the tubing. RTV substances also can restore the surface finish, but require approximately a 1-day cure time and generally are not suited for large-scale production. Attempts also have been made to reduce damage that occurs during manufacturing the fluid system, but modifying manufacturing processes can be difficult to implement and impractical.

### SUMMARY OF THE INVENTION

There is a need in the art, therefore, for an enhanced configuration of a triangular (crush) sealing O-ring gland assembly for a fluid system, which accounts for surface finish damage to a fluid tube component of the fluid system. The present disclosure describes a triangular (crush) sealing O-ring gland assembly in which the hypotenuse or long side of the triangular sealing groove is the outer surface of the fluid tube. With the hypotenuse or long side of the triangular sealing groove being the outer surface of the fluid tube, the higher sealing load and increased sealing area of the hypotenuse or long side is applied at the outer surface of the fluid tube. As a result, enhanced sealing is applied at the outer surface of the fluid tube, which sufficiently accounts for surface finish damage to the fluid tube that may have occurred during manufacturing of the fluid system. With the higher load and increased sealing area, imperfections in the surface finish of the fluid tube are better covered and filled by the O-ring material. To form a triangular sealing groove having the hypotenuse or long side being the outer surface of the fluid tube, a cone-shaped insert mates with an opposing cone shape formed into the rear end cap. The result of the mating of the two opposing cone shapes is to form a triangular (crush) geometry of the sealing groove that receives the O-ring, with the triangular groove hypotenuse or long side being the outer surface of the fluid tube.

An aspect of the invention, therefore, is a fluid system having a triangular crush geometry of the triangular sealing groove in which the hypotenuse or long side of the triangular sealing groove is an outer surface of the fluid tube. In exemplary embodiments, a fluid system includes a fluid manifold; a rear end cap fixed to the fluid manifold, the rear end cap having an internal first cone-shaped recess; and a fluid tube having an end positioned in the fluid manifold and that extends from the fluid manifold through the rear end cap, wherein the fluid manifold sources a fluid at the end of the fluid tube to flow through the fluid tube. The fluid system further includes a sealing insert that extends around a portion of the fluid tube, the sealing insert having a first end positioned in the fluid manifold and a second end positioned in the rear end cap, wherein the second end of the sealing insert has a second coned-shaped recess that is positioned as an opposing cone-shaped recess relative to the first coned-shaped recess of the rear end cap. The opposing first and second cone-shaped recesses form a triangular sealing groove in which a long side or hypotenuse of the triangular sealing groove is an outer surface of the fluid tube. Looking at such configuration in absence of the fluid tube, the opposing first and second cone-shaped recesses form a triangular sealing groove in which a long side of the triangular sealing groove is opposite from the first and second cone-shaped recesses. The fluid system further includes a sealing element positioned within the triangular sealing groove that is crushed to conform to the shape of the triangular sealing groove.

In an exemplary embodiment of the fluid system, the first coned-shaped recess and the second cone-shaped recess are of equal length and meet at a right angle, such that the triangular sealing groove is an isosceles right triangle having a hypotenuse corresponding to the outer surface of the fluid tube (or opposite from the first and second coned-shaped recesses) and legs corresponding to the first and second cone-shaped recesses.

In an exemplary embodiment of the fluid system, the first coned-shaped recess and the second cone-shaped recess meet at an angle from 90° to 120°.

In an exemplary embodiment of the fluid system, the sealing element is an O-ring seal.

In an exemplary embodiment of the fluid system, the sealing insert has an insert body positioned between the first and the second ends, and the insert body has external threads that mate with internal threads of the rear end cap to fix the sealing insert within the rear end cap.

In an exemplary embodiment of the fluid system, the first end of the sealing insert has a diameter that is smaller than a diameter of the second end and insert body of the sealing insert, whereby the insert body is positioned against an internal face of the fluid manifold.

In an exemplary embodiment of the fluid system, the fluid manifold is press fit over the end of the fluid tube and the first end of the sealing insert.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting a conventional crush seal configuration.

FIG. 2 is a drawing depicting an exemplary fluid system employing an enhanced crush seal configuration in accordance with embodiments of the present application.

FIG. 3 is a drawing depicting a close-up view of a portion of the fluid system of FIG. 2, particularly illustrating the triangular gland assembly to seal the system.

FIG. 4 is drawing depicting an exemplary pressure diagram for an example of a crush seal configuration in accordance with embodiments of the present application.

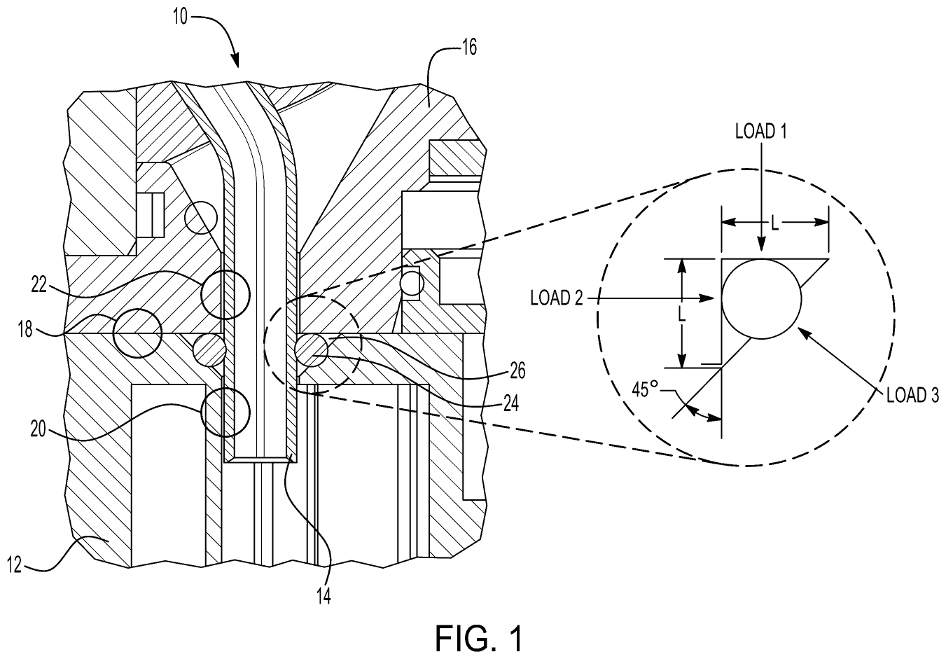

### DETAILED DESCRIPTION

Embodiments of the present application will now be described with reference to the drawings, wherein like reference numerals are used to refer to like elements throughout. It will be understood that the figures are not necessarily to scale.

FIG. 2 is a drawing depicting an exemplary fluid system 30 employing an enhanced crush seal configuration in accordance with embodiments of the present application. In general, FIG. 2 describes a triangular (crush) sealing O-ring gland assembly in which the hypotenuse or long side of the triangular sealing groove is the outer surface of the fluid tube. With the hypotenuse or long side of the triangular sealing groove being the outer surface of the fluid tube, the higher sealing load and increased sealing area of the hypotenuse (long side) is applied at the outer surface of the fluid tube. As a result, enhanced sealing is applied at the outer surface of the fluid tube, which sufficiently accounts for surface finish damage to the fluid tube that may have occurred during manufacturing of the fluid system. To form a triangular sealing groove having the hypotenuse (long side) being the outer surface of the fluid tube, a cone-shaped insert mates with an opposing cone-shaped recess formed in the rear end cap. The result of the mating of the two opposing cone shapes is to form a triangular (crush) geometry of the sealing groove that receives the O-ring, with the triangular groove hypotenuse or long side being the outer surface of the fluid tube.

An aspect of the invention, therefore, is a fluid system having a triangular crush geometry of the triangular sealing groove in which the hypotenuse or long side of the triangular sealing groove is an outer surface of the fluid tube. In exemplary embodiments, a fluid system includes a fluid manifold; a rear end cap fixed to the fluid manifold, the rear end cap having an internal first cone-shaped recess; and a fluid tube having an end positioned in the fluid manifold and that extends from the fluid manifold through the rear end cap, wherein the fluid manifold sources a fluid at the end of the fluid tube to flow through the fluid tube. The fluid system further includes a sealing insert that extends around a portion of the fluid tube, the sealing insert having a first end positioned in the fluid manifold and a second end positioned in the rear end cap, wherein the second end of the sealing insert has a second coned-shaped recess that is positioned as an opposing cone-shaped recess relative to the first coned-shaped recess of the rear end cap. The opposing first and second cone-shaped recesses form a triangular sealing groove in which a long side or hypotenuse of the triangular sealing groove is an outer surface of the fluid tube. Looking at such configuration in absence of the fluid tube, the opposing first and second cone-shaped recesses form a triangular sealing groove in which a long side of the triangular sealing groove is opposite from the first and second cone-shaped recesses. The fluid system further includes a sealing element positioned within the triangular sealing groove that is crushed to conform to the shape of the triangular sealing groove.

Referring specifically to the depiction of FIG. 2, the fluid system 30 includes a fluid manifold 32 that is fixed to a rear end cap 34. The fluid manifold 32 and the rear end cap 34 may be fixed to each other by any suitable fastening mechanism, such as for example bolts, screws, or comparable fasteners, or by using a bonding technique. The materials for the fluid manifold and rear end cap may be any suitable materials commonly used in fluid connection assemblies, such as for example various types of metals or rigid plastics. The fluid system 30 further includes a fluid tube 36 that has a tube end 37 positioned within the fluid manifold 32. The fluid tube 36 extends from the fluid manifold 32 and through the rear end cap 34 to deliver a fluid to system components downstream from the rear end cap 34. A common material used for the fluid tube 36 for many applications is copper tubing, although other suitable materials may be employed.

The fluid being delivered by the fluid system 30 may be any suitable fluid for various applications. In one common application, the fluid may be a coolant fluid that is delivered via the fluid tube 36 for cooling a motor, although comparable principles may apply to any comparable fluid system. Similarly as in conventional configurations, the fluid manifold 32 is a source of fluid to be sourced through the fluid tube 36 from the tube end 37 and extending through the rear end cap 34. To prevent fluid leakage, therefore, the various component interfaces must be sealed, and a triangular crush seal configuration is employed. Accordingly, the fluid system 30 defines a triangular sealing groove 38 in which there is positioned a sealing element 40, such as for example an O-ring seal. When the sealing element or O-ring seal 40 is positioned within the triangular sealing groove 38, the sealing element is crushed into the shape of the triangular groove to seal the interfaces of the different fluid system components.

To position the sealing element 40 within the triangular groove 38, the fluid system 30 further includes a sealing insert 42. The sealing insert 42 has a first end 44 and a second end 46 opposite from the first end 44, and an insert body 48 positioned between the first and second ends. The sealing insert 42 extends around a portion of the fluid tube 36, and the first end 44 is positioned in the fluid manifold 32 and the second end 46 is positioned in the rear end cap 34. The first end 44 may have a diameter smaller than a diameter of the insert body 48 and the second end 46. The fluid manifold 32 includes a recess 50 that is sized and shaped to receive the first end 44 of the sealing insert 42, whereby the larger-diameter insert body 48 of the sealing insert 42 is positioned against an internal face of the fluid manifold 32. The rear end cap 34 has a bore 52 sized and shaped to receive the insert body 48 and the second end 46 of the sealing insert 42. The sealing insert 42 has an internal passage 54 through which the fluid tube 36 extends, such that the sealing insert extends around a portion of the fluid tube. The sealing insert may be fixed within the rear end cap by any suitable mechanism. The insert body of the sealing insert may have external threads that mate with internal threads of the rear end cap to fix the sealing insert within the rear end cap. For example, the bore 52 of the rear end cap 34 and an outer surface of the insert body 48 of the sealing insert 42 may have cooperating screw threads 49 and 53, and/or the fluid manifold 32 may be press fit over the first end 44 of the sealing insert 42 and the end 37 of the fluid tube 36. Suitable combinations of press fit mating, threading, and/or adhesives or glues may be employed to secure the sealing insert within the fluid manifold and rear end cap.

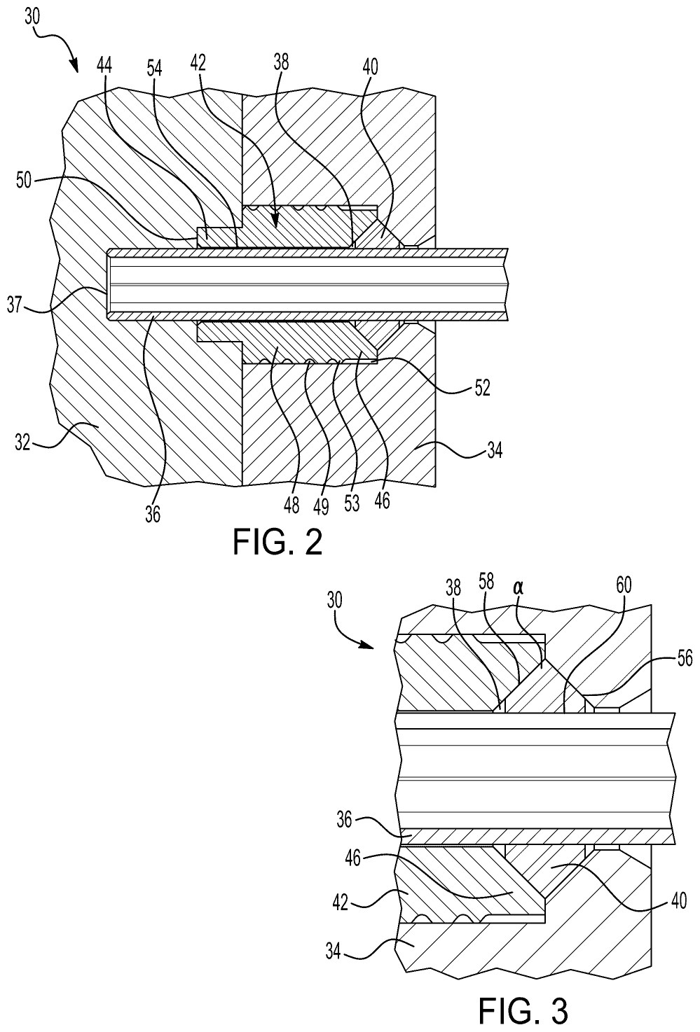

FIG. 3 is a drawing depicting a close-up view of a portion of the fluid system 30 of FIG. 2, particularly illustrating the triangular gland assembly to seal the system. To form the triangular sealing groove 38, the rear end cap 34 includes an internal first cone-shaped recess 56. The first cone-shaped recess 56 may be formed internally in the rear end cap 34 using any suitable manufacturing process, such as for example casting, machining, or molding. In addition, the second end 46 of the sealing insert 42 includes a second cone-shaped recess 58 that is positioned as an opposing cone-shaped recess relative to the internal first cone-shaped recess 56 of the rear end cap 34. As a result, when the sealing insert 42 is positioned within the rear end cap 32 and around the fluid tube 36, the opposing first and second cone-shaped recesses 56 and 58 meet at a base angle α. The first and second cone-shaped recesses 56 and 58 and an outer surface 60 of the fluid tube thereby form the triangular sealing groove 38. During assembly of the fluid system 30, the fluid tube is inserted through rear end cap, and the sealing element (e.g., O-ring seal) is positioned around the outer surface of the fluid tube and against the first cone-shaped recess formed in the rear end cap. The sealing insert is then mated to the rear end cap by threading, press fit, or the like as referenced above. As the sealing insert 42 is moved toward the in-use position shown in FIGS. 2 and 3, the second coned-shaped recess 58 contacts the O-ring 40 and forces the O-ring 40 against the first coned-shaped recess 56 and the outer surface 60 of the fluid tube 36, which ultimately crushes the O-ring 40 within the triangular sealing groove 38 formed by the opposing cone-shaped recess and outer tube surface. The fluid manifold is pressed fit or otherwise fixed over the ends of the fluid tube and sealing insert, and against the rear end cap. In this manner, the triangular crush seal configuration is achieved.

The base angle α of the triangular groove 38 is selected such that a long side of the triangular sealing groove 38 corresponds to the outer surface 60 of the fluid tube 36. In an exemplary embodiment, the first coned-shaped recess and the second cone-shaped recess meet at a right angle (i.e., the base angle α equals 90°), and the first and second cone-shaped recesses are of equal lengths, whereby the triangular sealing groove 38 is an isosceles right triangle having equal legs corresponding to surfaces of the first and second cone-shaped recesses 56 and 58 and the hypotenuse corresponding to the outer surface 60 of the fluid tube.

As described above in the background section, in an isosceles right triangle configuration the loads associated with the O-ring sealing element are approximately equal at the legs of the isosceles right triangle, and the load at the hypotenuse is approximately equal to square-root-two (or approximately 1.414) times the load at one of the legs. This results in a higher pressure and larger contact area being applied at the hypotenuse, with this higher pressure and wider sealing contact area generally providing enhanced sealing at the hypotenuse side of the triangular sealing groove relative to the legs of the triangular sealing groove. As referenced above, for manufacturing purposes conventional configurations typically position the hypotenuse of the triangular sealing groove as an internal surface of the fluid manifold. In contrast, by forming the triangular sealing groove 38 of fluid system 30 using the opposing first and second coned-shaped recesses 56/58 of sealing insert and rear end cap, the hypotenuse of the triangular sealing groove 38 is positioned as the outer surface 60 of the fluid tube 36. Accordingly, the greatest sealing effect is against the outer surface of the fluid tube, which is sufficient to account for the potential surface finish damage to the fluid tube referenced above. In this manner, the crush seal configuration of the present disclosure provides a more enhanced seal as compared to conventional configurations, insofar as leakage due to surface finish damage of the fluid tube is prevented.

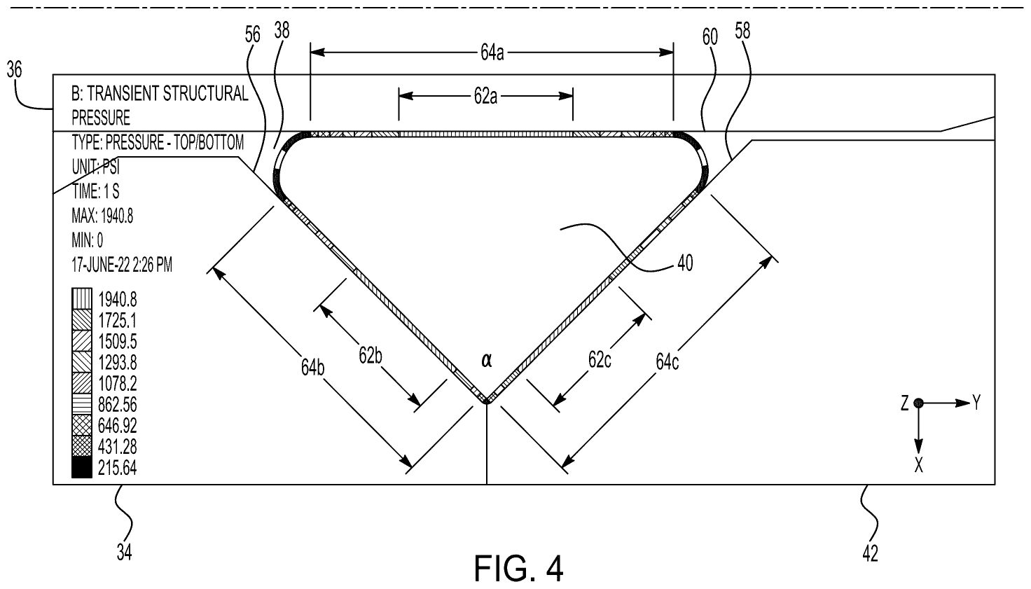

FIG. 4 is drawing depicting an exemplary pressure diagram for an example of a crush seal configuration in accordance with embodiments of the present application, which illustrates such enhanced sealing. This example corresponds to an isosceles right triangle configuration of the sealing grove. The loads at the sealing surfaces of the triangular sealing groove are not uniform, but rather are characterized by a high-pressure area that trails off through low-pressure areas, whereby a sealing load at the high-pressure area is greater than a sealing load at the low-pressure areas for a given sealing surface. Referring to FIG. 4, the hypotenuse sealing surface at the outer surface 60 of the fluid tube 36 includes a high-pressure area having a contact length 62a, and an overall contact length 64a. The overall contact length includes both the high-pressure area and the low-pressure areas on opposite sides of the high-pressure area, since there still is contact with the groove surface at the low-pressure areas although at a lower sealing load than at the high-pressure area. Similarly, the leg sealing surface at the first cone-shaped recess 56 of the rear end cap 34 includes a high-pressure area having a contact length 62b, and an overall contact length 64b. The leg sealing surface at the second cone-shaped recess 58 of the sealing insert 42 includes a high-pressure area having a contact length 62c, and an overall contact length 64c.

It was measured as shown in FIG. 4 that the overall contact length 64a of the hypotenuse sealing surface is approximately 1.27 times the overall contact lengths 64b and 64c of each of the leg sealing surfaces. In addition, it was measured that the contact length 62a of the high-pressure area of the hypotenuse sealing surface is approximately 1.22 to 1.34 times the contact lengths 62b and 62c of each of the high-pressure areas of the leg sealing surfaces. With both greater overall and high-pressure contact lengths of the hypotenuse sealing surface relative to each of the leg sealing surfaces, it is thereby demonstrated that enhanced sealing occurs at the hypotenuse sealing surface corresponding to the outer surface 60 of fluid tube 36, as compared to sealing at the leg sealing surfaces corresponding to the first and second coned-shaped recesses 56 and 58 respectively of the rear end cap 34 and the sealing insert 42. With the higher load and increased sealing area at the hypotenuse sealing surface against the fluid tube, imperfections in the surface finish of the fluid tube are better covered and filled by the O-ring material.

Embodiments have been described in connection with configuring the triangular sealing groove or gland as an isosceles right triangle. The sealing groove configuration as an isosceles right triangle has proven to provide effective sealing and is easy to manufacture and assemble. The precise angle of the base angle α can be varied to either a smaller or larger angle by altering the slope angle of one or both of the cone-shaped recesses, noting that enhanced sealing occurs at the outer surface of the fluid tube so long as the long side of the triangular sealing groove corresponds to the outer surface of the fluid tube. Accordingly, mathematically any base angle α above 60° will result in the long side of the triangular groove corresponding to the outer surface of the fluid tube. As the base angle α is increased, the sealing load at the long side of the triangular sealing groove also increases, and thus 90° is preferred for many applications for both effective performance and ease of manufacture and assembly. Increasing the base angle α further above 90° would further increase the sealing load at the long side of the triangular sealing groove. That said, increasing the base angle α becomes impractical as the triangular sealing groove becomes too shallow at large obtuse angles, and thus the O-ring either cannot be installed or may be destroyed when crushed within the sealing groove. For certain applications, a base angle α of up to about 120° may be suitable.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A fluid system comprising:
a fluid manifold;
a rear end cap fixed to the fluid manifold, the rear end cap having an internal first cone-shaped recess;
a fluid tube having an end positioned in the fluid manifold and that extends from the fluid manifold through the rear end cap, wherein the fluid manifold sources a fluid at the end of the fluid tube to flow through the fluid tube;
a sealing insert that extends around a portion of the fluid tube, the sealing insert having a first end positioned in the fluid manifold and a second end positioned in the rear end cap, wherein the second end of the sealing insert has a second coned-shaped recess that is positioned as an opposing cone-shaped recess relative to the first coned-shaped recess of the rear end cap;
wherein the opposing first and second cone-shaped recesses form a triangular sealing groove in which a long side of the triangular sealing groove is an outer surface of the fluid tube; and
a sealing element positioned within the triangular sealing groove that is crushed to conform to the shape of the triangular sealing groove.

2. The fluid system of claim 1, wherein the first coned-shaped recess and the second cone-shaped recess are of equal length and meet at a right angle, such that the triangular sealing groove is an isosceles right triangle having a hypotenuse corresponding to the outer surface of the fluid tube and legs corresponding to the first and second cone-shaped recesses.

3. The fluid system of claim 1, wherein the first coned-shaped recess and the second cone-shaped recess meet at an angle from 90° to 120°.

4. The fluid system of claim 1, wherein the sealing element is an O-ring seal.

5. The fluid system of claim 1, wherein the sealing insert has an insert body positioned between the first and the second ends, and the insert body has external threads that mate with internal threads of the rear end cap to fix the sealing insert within the rear end cap.

6. The fluid system of claim 5, wherein the first end of the sealing insert has a diameter that is smaller than a diameter of the second end and insert body of the sealing insert, whereby the insert body is positioned against an internal face of the fluid manifold.

7. The fluid system of claim 1, wherein the fluid manifold is press fit over the end of the fluid tube and the first end of the sealing insert.

8. A sealing fluid connection comprising:
a fluid manifold;
a rear end cap fixed to the fluid manifold, the rear end cap having an internal first cone-shaped recess; and
a sealing insert having a first end positioned in the fluid manifold and a second end positioned in the rear end cap, wherein the second end of the sealing insert has a second coned-shaped recess that is positioned as an opposing cone-shaped recess relative to the first coned-shaped recess of the rear end cap;
wherein the opposing first and second cone-shaped recesses form a triangular sealing groove in which a long side of the triangular sealing groove is opposite from the first and second cone-shaped recesses.

9. The sealing fluid connection of claim 8, wherein the first coned-shaped recess and the second cone-shaped recess are of equal length and meet at a right angle, such that the triangular sealing groove is an isosceles right triangle having a hypotenuse opposite from the first and second cone-shaped recesses and legs corresponding to the first and second cone-shaped recesses.

10. The sealing fluid connection of claim 8, wherein the first coned-shaped recess and the second cone-shaped recess meet at an angle from 90° to 120°.

11. The sealing fluid connection of claim 8, wherein the sealing insert has an insert body positioned between the first and the second ends, and the insert body has external threads that mate with internal threads of the rear end cap to fix the sealing insert within the rear end cap.

12. The sealing fluid connection of claim 11, wherein the first end of the sealing insert has a diameter that is smaller than a diameter of the second end and insert body of the sealing insert, whereby the insert body is positioned against an internal face of the fluid manifold.

13. The sealing fluid connection of claim 8, wherein the fluid manifold is press fit over the end of the fluid tube and the first end of the sealing insert.
